(19) United States
(12) Patent Application Publication
(10) Pub. No.: US 2019/0205597 A1
(43) Pub. Date: Jul. 4, 2019

(54) COVER MEMBER, AND PORTABLE INFORMATION TERMINAL AND DISPLAY DEVICE HAVING THE COVER MEMBER

(71) Applicant: AGC, Inc., Chiyoda-ku (JP)

(72) Inventor: Satoru TOMENO, Tokyo (JP)

(73) Assignee: AGC, Inc., Chiyoda-ku (JP)

(21) Appl. No.: 16/294,972

(22) Filed: Mar. 7, 2019

Related U.S. Application Data
(63) Continuation of application No. PCT/JP2017/031439, filed on Aug. 31, 2017.

(30) Foreign Application Priority Data
Sep. 9, 2016 (JP) 2016-176326

(51) Int. Cl. G06K 9/00; G06F 1/16; H04R 1/28

(52) U.S. Cl. CPC G06K 9/0002; G06K 9/00053; H04R 1/28; G06F 1/1607

(57) ABSTRACT

The present invention relates to a cover member having: a first main surface, and a second main surface which is a side on which an ultrasonic unit is to be disposed, in which the cover member includes a member having an acoustic impedance Z of 3 to 25 (×10⁶ kg/m²/s).

### TECHNICAL FIELD

The present invention relates to a cover member, and a portable information terminal and a display device each having the cover member.

### BACKGROUND ART

In recent years, as a high-level security measure in electronic equipment, biometric authentication techniques using a fingerprint etc. for personal authentication are gaining attention in place of a personal identification number etc. Among the biometric authentication techniques, a fingerprint authentication system has been used in cellular phones or tablets. In the fingerprint authentication system, optical sensors, thermosensitive sensors, pressure sensitive sensors, electrostatic capacitive sensors, etc. are used. The electrostatic capacitive sensors are considered to be excellent from the viewpoint of sensing sensitivity or power consumption.

An electrostatic capacitive sensor detects a local change of electrostatic capacitance in a site approached or touched by an object to be detected. Typically the electrostatic capacitive sensor measures a distance between an electrode disposed in the sensor and the object to be detected, based on the magnitude of the electrostatic capacitance. For example, Patent Document 1 discloses an electrostatic capacitive sensor packaging in which a hole is provided in a cover glass so that a sensor can detect an object to be detected, and a sensor cover is disposed on the hole.

However, authentication sensitivity of the electrostatic capacitive sensor depends on a state of the object to be detected, for example, whether a hand is wet or not. Thus, there is a problem that a false recognition rate may increase.

Therefore, attention is being paid to an ultrasonic sensor which can detect an object to be detected even if a foreign substance such as liquid lies between the sensor and the object to be detected, by ultrasonic waves permeating the foreign substance, so that security can be improved.

### BACKGROUND ART DOCUMENT

### Patent Document

Patent Document 1: WO2013/173773

### SUMMARY OF THE INVENTION

### Problems that the Invention is to Solve

When an ultrasonic sensor is combined with a sensor cover in place of a background-art electrostatic capacitive sensor, it is considered that ultrasonic waves emitted from the ultrasonic sensor may be attenuated by the sensor cover to thereby lower the authentication sensitivity.

The present invention has been developed in consideration of the aforementioned problem. An object of the present invention is to provide a cover member which hardly attenuates ultrasonic waves, and a portable information terminal and a display device each having the cover member.

### Means for Solving the Problems

The above-described object of the present invention is achieved by the following configurations.

(1) A cover member having:

a first main surface, and

a second main surface which is a side on which an ultrasonic unit is to be disposed,

in which the cover member includes a member having an acoustic impedance Z of 3 to 25 (×10⁶ kg/m²/s).

(2) The cover member according to (1), in which the member is a glass.
(3) The cover member according to (2), in which the glass is an inorganic glass.
(4) The cover member according to any one of (1) to (3), in which the member has a thickness of 0.1 mm to 1.5 mm.
(5) The cover member according to any one of (1) to (4), in which the member has a hole or a concave portion.
(6) The cover member according to any one of (1) to (5), which is to protect the ultrasonic unit.
(7) The cover member according to (6), in which the ultrasonic unit is an ultrasonic sensor.
(8) The cover member according to (5) or (6), in which a frequency of ultrasonic waves to be used in the ultrasonic unit is 1 MHz to 30 MHz.
(9) The cover member according to any one of (1) to (7), in which the member has a Young's modulus of 60 GPa or more.
(10) The cover member according to any one of (1) to (9), in which the first main surface has an arithmetic average roughness Ra of 5,000 nm or less.
(11) The cover member according to any one of (1) to (10), in which the member has a compressive stress layer in at least one of the main surfaces.
(12) A portable information terminal including the cover member according to any one of (1) to (11).
(13) A display device including the cover member according to any one of (1) to (11).
(14) An ultrasonic device including:

a cover member having a first main surface and a second main surface; and

an ultrasonic unit disposed on a side of the second main surface,

in which the cover member includes a member having an acoustic impedance Z of 3 to 25 (×10⁶ kg/m²/s).

(15) The ultrasonic device according to (14), in which the ultrasonic unit has a transmitter and a receiver, and a frequency of ultrasonic waves to be transmitted from the transmitter is 1 MHz to 30 MHz.
(16) The ultrasonic device according to (14) or (15), in which the member is an inorganic glass.
(17) The ultrasonic device according to any one of (14) to (16), in which the ultrasonic unit is an ultrasonic sensor.
(18) The ultrasonic device according to any one of (14) to (17), in which the member has a hole or a concave portion.

### Advantage of the Invention

According to the present invention, it is possible to provide a cover member which hardly attenuates ultrasonic waves, and a portable information terminal and a display device each having the cover member.

### BRIEF DESCRIPTION OF THE DRAWINGS

FIG. 1 is a schematic side view illustrating a state in which a finger as an object to be detected touches an ultrasonic device including a cover member and an ultrasonic unit.

FIG. 2 is a graph showing a relation between acoustic impedance of the cover member and an energy residual ratio in the configuration of FIG. 1.

FIG. 3A is a schematic side view illustrating a configuration in which a printed layer 9 has been added to the configuration of FIG. 1.

FIG. 3B is a graph showing a relation between acoustic impedance of the cover member and an energy residual ratio in the configuration of FIG. 3A.

### MODE FOR CARRYING OUT THE INVENTION

An embodiment of the present invention will be described below. However, the present invention is not limited to the following embodiment. In addition, various modifications, replacements, etc. can be made on the following embodiment without departing from the scope of the present invention.

### (Cover Member)

A cover member according to the present invention includes a member which can protect an ultrasonic unit and has an acoustic impedance Z of 3 to 25 (×10⁶ kg/m²/s). The cover member according to the present invention serves as a member for operating the ultrasonic unit with high performance, and particularly serves as a member for allowing an ultrasonic sensor to perform authentication with high sensitivity. In addition, the cover member is useful for protecting the ultrasonic unit. Incidentally, the term “protecting” means that a cover member is, for example, attached directly on the ultrasonic unit, disposed closely to the ultrasonic unit, disposed to be opposed to the ultrasonic unit with a gap, or disposed through a printed layer, or the like. Specifically, the term “protecting” means that a transmitter and a receiver of the ultrasonic unit which will be described later are covered with a cover member according to the present invention.

The acoustic impedance Z of the cover member according to the present invention is preferably 3 (×10⁶ kg/m²/s) or more. In this case, when an ultrasonic unit having a large acoustic impedance Z is combined with the cover member, ultrasonic waves can be hardly attenuated in the interface or the like between the ultrasonic unit and the cover member. Thus, the ultrasonic unit can show its desired effect. The acoustic impedance Z of the cover member according to the present invention is more preferably 5 (×10⁶ kg/m²/s) or more, and further more preferably 12 (×10⁶ kg/m²/s) or more.

The acoustic impedance Z of the cover member according to the present invention is preferably 25 (×10⁶ kg/m²/s) or less. When the cover member according to the present invention is used as a protective member for the ultrasonic unit, ultrasonic waves can be hardly attenuated in the interface between an object to be detected which has a small acoustic impedance Z, such as a fingerprint, and the cover member, even if the object to be detected is brought into contact with the cover member. Thus, the ultrasonic unit can show its desired effect. In addition, as will be described later, the acoustic impedance Z can be obtained as a product of density p of the cover member and acoustic velocity c. When the acoustic velocity c is fixed, the density p increases as the acoustic impedance Z increases. In this case, the weight of the cover member increases. However, when the acoustic impedance Z does not exceed the aforementioned range, the weight can be prevented from increasing even if the ultrasonic device 1 is used in a portable information terminal. The acoustic impedance Z of the cover member is more preferably 20 (×10⁶ kg/m²/s) or less, and further more preferably 18 (×10⁶ kg/m²/s) or less.

Incidentally, the acoustic impedance Z is an index indicating the degree with which acoustic waves can be transmitted easily, and it can be obtained by Expression (1).

Z=ρ×c (1)

(in Expression (1), the unit of the acoustic impedance Z is kg/m²/s, the unit of the density ρ is kg/m³, and the unit of the acoustic velocity c is m/s.)

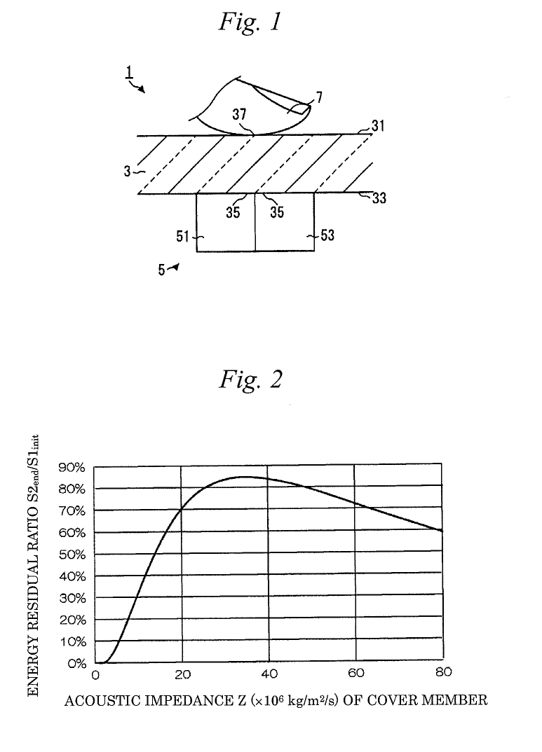

FIG. 1 is a schematic side view illustrating a state in which a finger as an object 7 to be detected touches the ultrasonic device 1 including the cover member 3 and the ultrasonic unit 5. The cover member 3 has a first main surface 31 to be touched by a user of the ultrasonic device 1, and a second main surface 33 included in the ultrasonic device 1 so that the ultrasonic unit 5 can be mounted thereon. The ultrasonic unit 5 includes a transmitter 51 for transmitting ultrasonic waves, and a receiver 53 for receiving ultrasonic waves. In addition, an interface 37 is located between the cover member 3 and the object 7 to be detected, and an interface 35 is located between the cover member 3 and the ultrasonic unit 5.

The ultrasonic device 1 detects the object 7 to be detected, in the following procedure. On such an event that the object 7 to be detected touches the first main surface 31 of the cover member 3, a start signal is transmitted to the ultrasonic unit 5. In response to the start signal, the transmitter 51 transmits an ultrasonic wave S1ᵢₙᵢₜ. The ultrasonic wave S1ᵢₙᵢₜ permeates the interface 35 and travels through the cover member 3. In the interface 37, the ultrasonic wave S1ᵢₙᵢₜ arrives at the object 7 to be detected. On this occasion, a part of the arrived ultrasonic wave is reflected by the object 7 to be detected, so as to form an ultrasonic wave S2. The ultrasonic wave S2 is transmitted toward the ultrasonic unit 5 sequentially through the interface 37, the cover member 3 and the interface 35. Finally, the ultrasonic wave S2 is received as an ultrasonic wave S2_{end} by the receiver 53.

Here, the energy of the ultrasonic wave S2_{end} arrived at the receiver 53 is much smaller than the energy of the ultrasonic wave S1ᵢₙᵢₜ transmitted from the transmitter 51. This is caused by attenuation of the ultrasonic wave in the interfaces 35 and 37, and attenuation of the ultrasonic wave inside the cover member 3. Of those attenuations, the attenuation of energy caused by scattering, reflection, etc. in the interfaces is significant. Thus, the former is the dominant factor attenuating the ultrasonic wave.

FIG. 2 is a graph in which a ratio S2_{end}/S1ᵢₙᵢₜ of the energy of the ultrasonic wave S2_{end} to the energy of the ultrasonic wave S1ᵢₙᵢₜ (hereinafter referred to as energy residual ratio) in the configuration of FIG. 1 is plotted, where the ordinate designates the energy residual ratio S2_{end}/S1ᵢₙᵢₜ and the abscissa designates the acoustic impedance Z of the cover member. When the acoustic impedance Z of the cover member is 3 (×10⁶ kg/m²/s) or more, the energy residual ratio reaches 1% or more. Thus, the energy high enough to allow the ultrasonic unit 5 to function properly can be obtained. Incidentally, the acoustic impedances of the ultrasonic unit 5 and the object 7 to be detected are set at 30 (×10⁶ kg/m²/s) and 1.4 (×10⁶ kg/m²/s) respectively.

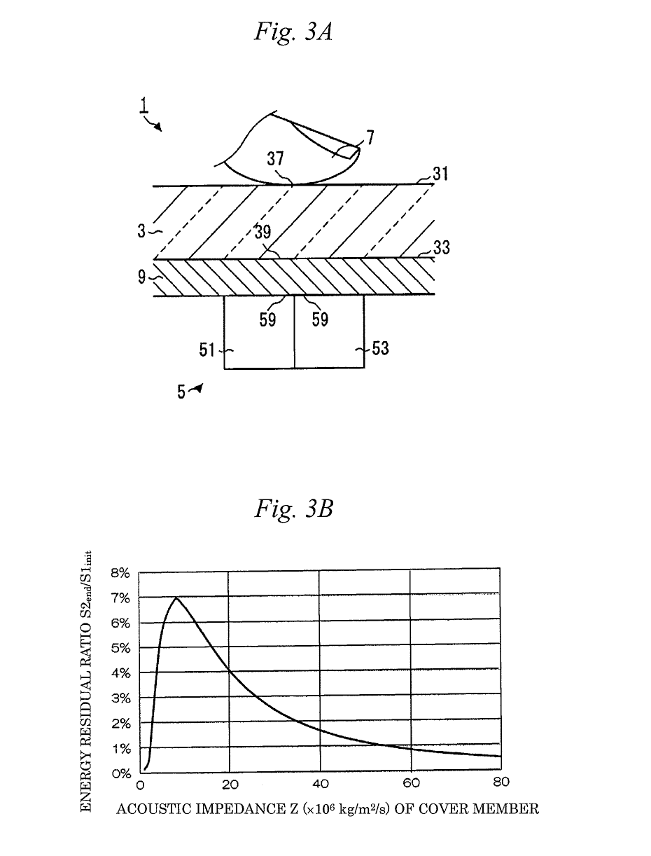

In addition, as illustrated in FIG. 3A, a printed layer 9 may be formed in the ultrasonic device 1 so as to serve as a concealing layer by which a user cannot visually recognize internal devices. In the configuration of FIG. 3A, the energy residual ratio is roughly estimated in the same manner as in FIG. 2. FIG. 3B shows a graph in which the result of the estimation is plotted. In the configuration in which the printed layer 9 is also combined, the energy residual ratio is reduced when the acoustic impedance Z of the cover member is larger than a certain value. When the acoustic impedance Z of the cover member is 25 (×10⁶ kg/m²/s) or less, an energy residual ratio of 3% or more can be obtained by the cover member, so that energy high enough to allow the ultrasonic unit 5 to function properly can be obtained without increasing the weight of the ultrasonic device 1. Incidentally, the acoustic impedance of the printed layer 9 is set at 4 (×10⁶ kg/m²/s).

When a not-shown adhesive layer or a functional layer such as an antireflection-treated layer or an antifouling-treated layer is added to the configuration of the ultrasonic device 1, the energy residual ratio is further reduced. In order to obtain the ultrasonic wave S2_{end} with energy high enough to allow the ultrasonic unit 5 to function properly in spite of such an additional constituent, it is estimated that an energy residual ratio of 3% or more is required in the configuration of FIG. 3A. In this case, it is particularly preferable that the acoustic impedance Z of the cover member 3 has a lower limit value at 5 (×10⁶ kg/m²/s) or more and an upper limit value at 25 (×10⁶ kg/m²/s) or less.

### (Member)

As the member of the cover member 3, glass, silicon, and the like may be mentioned. As the glass, an inorganic glass and an organic glass may be mentioned. Examples of such an organic glass include polycarbonate, and polymethyl methacrylate. When the cover member 3 is used in a portable information terminal or a display device, the glass is preferred from the viewpoint of safety or strength. Further, the inorganic glass is preferred because when a display device using the inorganic glass for the cover member 3 is used as an on-vehicle member, high heat resistance and high weather resistance can be obtained.

When the member of the cover member 3 is inorganic glass, it is preferable that at least one main surface thereof is subjected to strengthening treatment. As a result, required mechanical endurance and scratch resistance can be secured. Either physically strengthening treatment or chemically strengthening treatment may be used as the strengthening treatment. However, chemically strengthening treatment is preferred because it can strengthen even a comparatively thin glass.

Generally, chemically strengthened glass has a compressive stress (CS) layer formed in a surface of the glass, with a depth of layer (DOL) that bears compressive stress, and a central tension (CT) formed inside the glass. When the glass has a CS layer in at least one main surface thereof, mechanical endurance and scratch resistance can be given to the glass surface.

When the chemically strengthening treatment is not carried out, the glass may have a composition such as alkali-free glass or soda lime glass. When the chemically strengthening treatment is carried out, the glass may have a composition such as soda-lime glass, soda-lime silicate glass, aluminosilicate glass, borate glass, lithium aluminosilicate glass, or borosilicate glass. Aluminosilicate glass is preferred because large stress can be easily introduced into the glass by the strengthening treatment to thereby obtain a high-strength glass even if the thickness of the glass is thin.

A thickness t of the cover member 3 according to the embodiment is preferably 1.5 mm or less, more preferably 1.3 mm or less, further more preferably 0.8 mm or less, and particularly preferably 0.5 mm or less. When the cover member 3 is thinner, attenuation of ultrasonic waves in the cover member 3 can be suppressed to improve the functionality of the ultrasonic unit 5. On the other hand, the lower limit of the thickness of the cover member 3 according to the embodiment is not particularly limited. However, when the cover member 3 is too thin, the cover member 3 tends to be too low in strength to show a proper function as the cover member 3. Accordingly, the thickness t of the cover member 3 is preferably 0.1 mm or more, and more preferably 0.3 mm or more.

When the cover member 3 according to the embodiment is provided above the ultrasonic unit 5, only the region of the cover member 3 opposed to the ultrasonic unit 5 needs to have the aforementioned thickness t. Accordingly, a region of the cover member 3 where the ultrasonic unit 5 is not disposed may have a thickness larger than 1 mm. In this manner, the rigidity of the cover member can be enhanced.

In addition, in the cover member 3 according to the embodiment, the first main surface 31 may be formed into a three-dimensional shape. The first main surface 31 may be formed into a shape curved as a whole, or may be formed into a shape having a bent portion.

The Young's modulus of the cover member 3 according to the embodiment is preferably 60 GPa or more, more preferably 65 GPa or more, and further more preferably 70 GPa or more. When the Young's modulus of the cover member 3 is 60 GPa or more, the cover member 3 can be sufficiently prevented from being damaged due to collision with an external colliding object. In addition, when the ultrasonic unit 5 is mounted on a portable information terminal or the like, the cover member 3 can be sufficiently prevented from being damaged due to falling or collision of the portable information terminal or the like. Further, it is possible to sufficiently prevent damage or the like on the ultrasonic unit 5 protected by the cover member 3. The upper limit of the Young's modulus of the cover member 3 according to the embodiment is not particularly limited. However, from the viewpoint of productivity, the Young's modulus is preferably 200 GPa or less, and more preferably 150 GPa or less. Incidentally, the Young's modulus of the cover member 3 can be calculated from measurements of a test piece 20 mm long, 20 mm wide and 10 mm thick by an ultrasonic method based on JIS R 1602 (1995) in Japanese Industrial Standards.

The Vickers hardness of the cover member 3 according to the embodiment is preferably 400 Hv (3.9 GPa) or more, and more preferably 500 Hv (4.9 GPa) or more. When the Vickers hardness of the cover member 3 is 400 Hv or more, the cover member 3 can be sufficiently prevented from being scratched due to collision with an external colliding object. In addition, when the ultrasonic unit 5 is mounted on a portable information terminal or the like, the cover member 3 can be sufficiently prevented from being scratched due to falling or collision of the portable information terminal or the like. Further, it is possible to sufficiently prevent scratch or the like on the ultrasonic unit 5 protected by the cover member 3. The upper limit of the Vickers hardness of the cover member 3 according to the embodiment is not particularly limited. However, when the Vickers hardness is too high, it may be impossible to polish or process the cover member 3. Accordingly, the Vickers hardness of the cover member 3 is preferably 1,200 HV (11.8 GPa) or less, and more preferably 1,000 Hv (9.8 GPa) or less.

Arithmetic average roughness Ra in the first main surface 31 of the cover member 3 according to the embodiment to be touched by a user is preferably 5,000 nm or less, more preferably 3,000 nm or less, and further more preferably 2,000 nm or less. When the cover member 3 is used for the ultrasonic unit 5, a gap is hardly formed between the object 7 to be detected and the cover member 3. Thus, the ultrasonic unit 5 functions with high accuracy. Particularly when an ultrasonic sensor is used as an ultrasonic unit 5 so as to detect a fingerprint as the object 7 to be detected, high sensing sensitivity can be obtained. The lower limit of the arithmetic average roughness Ra in the first main surface 31 of the cover member 3 according to the embodiment is not particularly limited. However, the arithmetic average roughness Ra is, for example, preferably 0.1 nm or more, more preferably 0.15 nm or more, and further more preferably 0.5 nm or more.

### (Ultrasonic Unit)

The ultrasonic unit 5 is not particularly limited as long as it is a device which includes a transmitter 51 for transmitting ultrasonic waves and a receiver 53 for receiving ultrasonic waves and which can detect the object 7 to be detected using ultrasonic waves. However, an ultrasonic sensor is particularly preferred as the ultrasonic unit 5. When the cover member 3 according to the embodiment is used for the ultrasonic sensor, the cover member 3 can serve as a protective member high in strength and light in weight, and the sensing sensitivity of the ultrasonic sensor can be kept high.

In addition, the frequency of the ultrasonic waves of the ultrasonic unit 5 is preferably 1 MHz to 30 MHz, more preferably 10 MHz to 25 MHz, and further more preferably 15 MHz to 20 MHz. When the frequency is within the aforementioned range, the ultrasonic waves are hardly attenuated, and easily reflect from the object. Thus, it is possible to obtain a high-accuracy ultrasonic unit 5.

### (Ultrasonic Device)

The ultrasonic device 1 including the cover member 3 according to the embodiment and the ultrasonic unit 5 is not particularly limited. Specific examples of the ultrasonic device 1 include a portable information terminal such as a cellular phone and a tablet, a display device further including a display portion, a medical device, and a large-sized security device for immigration control or the like.

When the cover member 3 according to the embodiment is used in a portable information terminal or a display device, the cover member 3 can serve as a protective member high in strength and light in weight. In addition, the sensing sensitivity of the ultrasonic sensor can be kept high.

### <Modification>

The present invention is not limited to only the aforementioned embodiment, but various improvements, design changes, etc. can be made without departing from the gist of the present invention. Specific procedure, structure, etc. for carrying out the present invention may be replaced by another structure etc. as long as the object of the present invention can be attained.

For example, the cover member 3 may be subjected to the steps and treatments which will be described later.

### (Arithmetic Average Roughness Ra of Second Main Surface)

Arithmetic average roughness Ra in the second main surface 33 of the cover member 3 according to the embodiment is not particularly limited, but it is preferably 5,000 nm or less, more preferably 3,000 nm or less, and further more preferably 2,000 nm or less. When the ultrasonic unit 5 is attached and installed on the second main surface 33, a gap is hardly formed between the ultrasonic unit 5 and the cover member 3. Thus, the ultrasonic unit 5 functions with high accuracy. Particularly when an ultrasonic sensor is used as the ultrasonic unit 5 so as to detect a fingerprint as the object 7 to be detected, high sensing sensitivity can be obtained. The lower limit of the arithmetic average roughness Ra in the second main surface 33 of the cover member 3 according to the embodiment is not particularly limited. However, the arithmetic average roughness Ra is, for example, preferably 0.1 nm or more, more preferably 0.15 nm or more, and further more preferably 0.5 nm or more.

### (Other Roughness in First Main Surface and Second Main Surface)

Maximum height roughness Rz in the first main surface 31 and the second main surface 33 is preferably 5,000 nm or less, more preferably 4,500 nm or less, and further more preferably 4,000 nm or less. When the maximum height roughness Rz is 5,000 nm or less, it is easy to follow irregularities of the fingerprint as the object to be detected. Thus, detection sensitivity is improved. The maximum height roughness Rz in the first main surface 31 and the second main surface 33 is preferably 0.1 nm or more, more preferably 0.15 nm or more, and further more preferably 0.3 nm or more. When the maximum height roughness Rz is 0.1 nm or more, the object to be detected is hardly displaced during authentication. Thus, the reliability of the authentication is improved.

As other roughness of the first main surface 31 and the second main surface 33, for example, root mean square surface roughness Rq is preferably 0.3 nm or more and 5,000 nm or less from the viewpoint of surface roughness and finger slidability. Maximum sectional height roughness Rt is preferably 0.5 nm or more and 5,000 nm or less from the viewpoint of surface roughness and finger slidability. Maximum peak height roughness Rp is preferably 0.3 nm or more and 5,000 nm or less from the viewpoint of surface roughness and finger slidability. Maximum valley depth roughness Rv is preferably 0.3 nm or more and 5,000 nm or less from the viewpoint of surface roughness and finger slidability. Average length roughness Rsm is preferably 0.3 nm or more and 10,000 nm or less from the viewpoint of surface roughness and finger slidability. Kurtosis roughness Rku is preferably 1 to 3 from the viewpoint of texture. Skewness roughness Rsk is preferably −1 to 1 from the viewpoint of uniformity of visibility, texture, etc. Each of these is roughness based on a roughness curve R, but waviness W or a sectional curve P correlating thereto may be defined, without any particular limitation.

### (Glass Composition)

In cases where the member of the cover member 3 is inorganic glass, as a specific glass composition, a glass containing, as a composition expressed by mol % in terms of oxide, 50-80% of SiO₂, 0.1-25% of Al₂O₃, 3-30% of Li₂O+Na₂O+K₂O, 0-25% of MgO, 0-25% of CaO and 0-5% of ZrO₂ may be mentioned. More specifically, the following glass compositions may be mentioned. Incidentally, for example, the phrase “contains 0-25% of MgO” means that MgO is not essential but may be contained up to 25%. Glass having the composition (i) belongs to soda-lime silicate glass, and glass having the composition (ii) or (iii) belongs to aluminosilicate glass.

(i) A glass containing, as a composition expressed by mol % in terms of oxide, 63-73% of SiO₂, 0.1-5.2% of Al₂O₃, 10-16% of Na₂O, 0-1.5% of K₂O, 0-5% of Li₂O, 5-13% of MgO, and 4-10% of CaO.
(ii) A glass containing, as a composition expressed by mol % in terms of oxide, 50-74% of SiO₂, 1-10% of Al₂O₃, 6-14% of Na₂O, 3-11% of K₂O, 0-5% of Li₂O, 2-15% of MgO, 0-6% of CaO and 0-5% of ZrO₂, in which the total content of SiO₂ and Al₂O₃ is 75% or less, the total content of Na₂O and K₂O is 12-25%, and the total content of MgO and CaO is 7-15%.
(iii) A glass containing, as a composition expressed by mol % in terms of oxide, 68-80% of SiO₂, 4-10% of Al₂O₃, 5-15% of Na₂O, 0-1% of K₂O, 0-5% of Li₂O, 4-15% of MgO, and 0-1% of ZrO₂.
(iv) A glass containing, as a composition expressed by mol % in terms of oxide, 67-75% of SiO₂, 0-4% of Al₂O₃, 7-15% of Na₂O, 1-9% of K₂O, 0-5% of Li₂O, 6-14% of MgO, and 0-1.5% of ZrO₂, in which the total content of SiO₂ and Al₂O₃ is 71-75%, the total content of Na₂O and K₂O is 12-20%, and the content of CaO is less than 1% if contained.

Further, when the glass is colored and used, a coloring material may be added within a range not impairing the attainment of a desired chemically strengthened property thereof. Examples of such coloring materials include Co₃O₄, MnO, MnO₂, Fe₂O₃, NiO, CuO, Cu₂O, Cr₂O₃, V₂O₅, Bi₂O₃, SeO₂, TiO₂, CeO₂, Er₂O₃, Nd₂O₃, etc. which are metal oxides of Co, Mn, Fe, Ni, Cu, Cr, V, Bi, Se, Ti, Ce, Er and Nd having light absorption in a visible region.

When a colored glass is used as the inorganic glass, the glass may contain a coloring component (at least one component selected from the group consisting of metal oxides of Co, Mn, Fe, Ni, Cu, Cr, V, Bi, Se, Ti, Ce, Er and Nd) in a range of 7% or less when expressed by mol % in terms of oxide. When the coloring component exceeds 7%, the glass tends to be devitrified. The content of the coloring component is preferably 5% or less, more preferably 3% or less, and further more preferably 1% or less. In addition, the glass may contain SO₃, chloride, fluoride, etc. serving appropriately as a refining agent when the glass is melted.

### (Method for Producing Glass)

When the member of the cover member 3 is inorganic glass, each step in a method for producing the inorganic glass is not particularly limited, but may be selected suitably. Typically, known steps may be applied. For example, raw materials of respective components are mixed to have a composition which will be described later, and heated to be melted in a glass melting furnace. The glass is homogenized by bubbling, stirring, addition of a refining agent, etc., and molded into a glass plate with a predetermined thickness by a known molding method. Then, the glass plate is gradually cooled down.

Examples of a method for molding the glass include a float process, a press process, a fusion process, a down-draw process, and a roll-out process. Particularly, the float process is preferred because it is suitable for mass production. In addition, continuous molding processes other than the float process, that is, the fusion process and the down-draw process are also preferred. In addition, when the colored glass is molded, the roll-out process may be optimal. In addition, when the glass is formed and used in another shape than the flat sheet-like shape, such as a concave shape or a convex shape, the glass molded into a flat sheet-like shape or a block-like shape is heated again, and press-molded in a molten state, or poured onto a press mold and press-molded. Thus, the glass can be molded into a desired shape.

The molded glass is ground and polished if necessary, and chemically strengthened. The glass is then washed and dried. Thereafter, the glass is subjected to processing such as cutting, polishing, etc., to obtain the cover member 3.

### (Chemically Strengthening Treatment)

When the cover member 3 is chemically strengthened, a compressive stress layer is formed in the surface thereof to thereby enhance the strength and the scratch resistance. The chemically strengthening treatment is a treatment using a molten salt at nearly 450° C. so that alkali metal ions (typically Li ions or Na ions) located in the main surface of the cover member 3 and each having a small ion radius are replaced by alkali metal ions each having a larger ion radius (typically Na ions or K ions for Li ions, or K ions for Na ions) to thereby form a compressive stress layer in the glass surface. The chemically strengthening treatment can be carried out by a known method. Typically the glass is immersed in a molten salt of potassium nitrate. About 10 mass % of potassium carbonate may be added to the molten salt and used. As a result, cracking can be eliminated from a surface layer of the glass so that a high-strength glass can be obtained. When a silver component such as silver nitrate is mixed into the potassium nitrate at the time of chemical strengthening, the glass has silver ions in its surface due to ion exchange. Thus, an antibacterial property can be given to the glass. In addition, the chemically strengthening treatment does not have to be carried out at one time, but may be, for example, carried out twice or more times on different conditions.

A compressive stress layer is formed in the main surface of the cover member 3. The compressive stress (CS) of the compressive stress layer is preferably 500 MPa or more, more preferably 550 MPa or more, further more preferably 600 MPa or more, and particularly preferably 700 MPa or more. As the compressive stress (CS) increases, the mechanical strength of the strengthened glass increases. On the other hand, when the compressive stress (CS) is too high, there is a concern that the tensile stress inside the glass may be extremely high. Therefore, the compressive stress (CS) is preferably set to 1,800 MPa or less, more preferably set to 1,500 MPa or less, and further more preferably set to 1,200 MPa.

The depth of the compressive stress layer (DOL) formed in the main surface of the cover member 3 is preferably 5 μm or more, more preferably 8 μm or more, and further more preferably 10 μm or more. On the other hand, when the DOL is too large, there is a concern that the tensile stress inside the glass may be extremely high. Therefore, the depth of the compressive stress layer (DOL) is preferably 180 μm or less, more preferably 150 μm or less, further more preferably 80 μm or less, and typically 50 μm or less.

In addition, the cover member 3 may be subjected to the following steps and treatments.

### (Grinding/Polishing Step)

At least one main surface of the cover member 3 may be subjected to grinding/polishing.

### (Perforating Step)

A hole may be formed in at least a part of the cover member 3. The hole may penetrate the cover member 3 or not penetrate the cover member 3. When the hole does not penetrate the cover member 3, the hole is a concave portion. Perforating may be performed by mechanical processing with a drill, a cutter or the like, optical processing with a laser or the like, or etching using hydrofluoric acid or the like. The perforating method is not particularly limited. In addition, those processing methods may be combined.

The opening diameter (in terms of the true circle calculated from the area) of the hole or the concave portion is not particularly limited. However, the opening diameter is preferably 10 μm or more, more preferably 50 μm or more, and further more preferably 100 μm or more. Thus, transmitted ultrasonic waves or the like can be hardly attenuated, and sensing can have high sensitivity. The opening diameter is preferably 5 mm or less, more preferably 3 mm or less, and further more preferably 2 mm or less. Thus, good appearance can be obtained while the strength of the glass is kept.

A plurality of holes or concave portions may be formed. When a plurality of holes or concave portions are formed, an opening pitch is preferably 0.1 mm or more and 3 mm or less, and more preferably 0.1 mm or more and 2 mm or less. When a plurality of holes or concave portions are formed, the transmitted ultrasonic waves or the like can be further hardly attenuated. Thus, the sensing sensitivity is improved. On the other hand, due to the formation of a plurality of holes or concave portions, the mechanical strength is generally reduced. When the pitch is set to be not less than the lower limit, the reduction of the mechanical strength can be suppressed to obtain a good cover member. The opening shape of each hole or concave portion is not particularly limited, but may be circular or quadrangular.

### (Edge Surface Processing)

An edge surface of the cover member 3 may be subjected to processing such as chamfering. When the cover member 3 is glass, it is preferable that processing such as so-called R-chamfering or C-chamfering is performed by mechanical grinding. However, another processing such as etching may be performed. The edge surface processing is not particularly limited.

### (Surface Treatment Step)

A step of forming various surface-treated layers in required places of the cover member 3 may be performed. Examples of the surface-treated layers include an antireflection-treated layer, an antifouling-treated layer, and an antiglare-treated layer. Those surface-treated layers may be used together. A surface where each surface-treated layer is formed may be either the first main surface 31 or the second main surface 33 of the cover member 3.

### [Antireflection-Treated Layer]

The antireflection-treated layer is a layer which provides an effect of reduction in reflectivity to thereby reduce glare caused by reflection of light. When used in a display device, the antireflection-treated layer also serves as a layer which can improve transmittance of light from the display device to thereby improve visibility of the display device.

When the antireflection-treated layer is an antireflection film, the antireflection film is preferably formed on the first main surface 31 or the second main surface 33 of the cover member 3. However, there is no limitation about the formation thereof.

The configuration of the antireflection film is not limited as long as it can suppress reflection of light. For example, the antireflection film may have a configuration in which a high refractive index layer having a refractive index of 1.9 or higher at a wavelength of 550 nm and a low refractive index layer having a refractive index of 1.6 or lower at the same wavelength are stacked, or may have a configuration including a layer in which hollow particles or holes are mixed in a film matrix so as to have a refractive index of 1.2 to 1.4 at the wavelength of 550 nm.

### [Antifouling-Treated Layer]

The antifouling-treated layer is a layer which suppresses adhesion of organic substances and inorganic substances to the surface, or a layer which provides an effect that even if organic substances and inorganic substances have adhered to the surface, the adhered substances can be removed easily by cleaning such as wiping.

When the antifouling-treated layer is formed as an antifouling film, it is preferable that the antifouling film is formed on the first main surface 31 and the second main surface 33 of the cover member 3 or other surface-treated layers formed thereon. The antifouling-treated layer is not limited as long as it can provide an antifouling property. Particularly it is preferable that the antifouling-treated layer is made of a fluorine-containing organic silicon compound coating obtained by hydrolysis condensation reaction of a fluorine-containing organic silicon compound.

### (Printed Layer Forming Step)

The printed layer 9 may be formed by various printing methods and various inks (printing materials) in accordance with application. Examples of the printing methods include spray printing, inkjet printing, and screen printing. By those methods, excellent printing can be performed even on a sheet-like glass with a large area. Particularly according to the spray printing, printing can be performed easily on the cover member 3 having a bent portion, and surface roughness of the printed surface can be adjusted easily. On the other hand, according to the screen printing, a desired printing pattern can be formed easily to have a uniform average thickness over a sheet-like glass with a large area. In addition, a plurality of inks may be used. However, it is preferable that one and the same ink is used from the viewpoint of adhesion of the printed layer 9. The ink for forming the printed layer 9 may be either an organic one or an inorganic one. The thickness of the printed layer 9 is preferably 10 pin or more from the viewpoint of concealment, and preferably 100 μm or less from the viewpoint of design.

### (Adhesive Layer Forming Step)

An adhesive layer may be formed, for example, in order to fix the ultrasonic unit 5 to the cover member 3 or the printed layer 9. The adhesive layer is not particularly limited. However, for example, a transparent resin layer obtained by curing a liquid curable resin composition may be used. Examples of the curable resin composition include a photosetting resin composition, and a thermosetting resin composition. In addition, OCA resin formed into a film-like shape separately in advance may be attached. A method for forming the adhesive layer is not particularly limited. For example, a die coater or a roll coater may be used. The thickness of the adhesive layer is preferably 1 μm or more in order to surely attain the fixation, and preferably 20 μm or less from the viewpoint of design.

### EXAMPLES

Examples of the present invention will be described. The present invention is not limited to the following Examples. Incidentally, Examples 1 to 18 are working examples, and Example 19 is a comparative example.

### Examples 1 to 14, and Examples 16 to 19

For each of Examples 1 to 14, and Examples 16 to 19, glass raw materials in general use such as oxides, hydrates, carbonates, nitrates, etc. were suitably selected and mixed so as to obtain a glass having a composition shown in Table 1 and Table 2 and expressed by mol %, and portions were weighed out which formed 1,000 g of glass.

Next, the mixed raw materials were put into a crucible made of platinum, the crucible with the mixed raw materials was put into a resistance heating electric furnace at 1,500 to 1800° C., and the mixed raw materials was melted for about 4 hours, degassed and homogenized. Molten glass thus obtained was poured into a mold, and kept for 1 hour at a temperature not lower than a glass transition temperature thereof. Thereafter, the molten glass was cooled down to a room temperature at a rate of 1° C./min. Thus, a glass block was obtained. The glass block was cut and ground, and finally the two surfaces thereof were mirror-finished. Thus, a sheet-like glass measuring 50 mm by 50 mm and having a thickness of 0.5 mm was obtained for each Example.

### Example 15

A quartz glass made by AGC Inc. was processed into a sheet-like glass measuring 50 mm by 50 mm and having a thickness of 0.5 mm. This was used as Example 15.

Chemically strengthening treatment was performed on the sheet-like glass according to each of Examples 1 to 7, so as to obtain a chemically strengthened glass according to each of Examples 1 to 7. As for chemically strengthening conditions, the glass was immersed for 1 to 6 hours in a molten salt of 100% potassium nitrate at 425 to 450° C.

As for the chemically strengthened glasses according to Examples 1 to 7 and the glasses according to Examples 8 to 19, density (kg/m³), Young's modulus (GPa), compressive stress value (MPa), depth of compressive stress layer (μm), acoustic velocity (m/s), and acoustic impedance (<10⁶ kg/m²/s) were measured or calculated. The results are shown in Table 1 and Table 2.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| | mol % | mol % | mol % | mol % | mol % | mol % | mol % | mol % | mol % |
| SiO₂ | 72 | 67 | 67 | 68 | 67 | 56 | 69 | 65 | 68 |
| Al₂O₃ | 1 | 5 | 11 | 11 | 13 | 17 | 3 | 6 | 5 |
| B₂O₃ | | | | | 4 | | | | |
| MgO | 6 | 3 | 6 | 6 | 2 | 3 | 6 | 8 | 10 |
| CaO | 9 | 5 | 1 | | | | 8 | 7 | |
| SrO | | 5 | | | | | | 1 | |
| BaO | | 4 | | | | | | | |
| Li₂O | | | | | | | | | |
| Na₂O | 12 | 5 | 13 | 15 | 14 | 17 | 14 | 5 | 5 |
| K₂O | | 4 | 2 | | | | | 7 | 8 |
| ZrO₂ | | 2 | | | | | | 1 | |
| P₂O₅ | | | | | | 7 | | | |
| TiO₂ | | | | | | | | | 4 |
| Ta₂O₅ | | | | | | | | | |
| Bi₂O₃ | | | | | | | | | |
| Ga₂O₃ | | | | | | | | | |
| PbO | | | | | | | | | |
| Total | 100 | 100 | 100 | 100 | 100 | 100 | 100 | 100 | 100 |
| density (×10³ kg/m³) | 2.49 | 2.77 | 2.46 | 2.43 | 2.40 | 2.42 | 2.50 | 2.56 | 2.47 |
| Young's modulus | 73 | 76 | 73 | 72 | 69 | 70 | 71 | 76 | 72 |
| (GPa) | | | | | | | | | |
| compressive stress | 600 | 400 | 726 | 928 | 875 | 727 | 650 | — | — |
| value (MPa) | | | | | | | | | |
| depth of compressive | 7 | 9 | 53 | 47 | 44 | 83 | 10 | — | — |
| stress layer (μm) | | | | | | | | | |
| acoustic velocity (m/s) | 5415 | 5238 | 5447 | 5421 | 5362 | 5376 | 5331 | 5449 | 5399 |
| acoustic impedance | 13.5 | 14.5 | 13.4 | 13.2 | 12.9 | 13.0 | 13.3 | 13.9 | 13.3 |
| (×10⁶ kg/m²/s) | | | | | | | | | |

TABLE 2

| | Ex. 10 | Ex. 11 | Ex. 12 | Ex. 13 | Ex. 14 | Ex. 15 | Ex. 16 | Ex. 17 | Ex. 18 | Ex. 19 |
|---|---|---|---|---|---|---|---|---|---|---|
| | mol % | mol % | mol % | mol % | mol % | mol % | mol % | mol % | mol % | mol % |
| SiO₂ | 62 | 65 | 66 | 60 | 50 | 100 | | | | 40 |
| Al₂O₃ | 13 | 12 | 11 | 10 | 20 | | | | | 30 |
| B₂O₃ | | | 8 | | | | 80 | 80 | | |
| MgO | 3 | | 5 | 30 | 30 | | | | | |
| CaO | | | 5 | | | | | | | |
| SrO | | | 5 | | | | | | | |
| BaO | | | | | | | | | | |
| Li₂O | 10 | 12 | | | | | 20 | | | |
| Na₂O | 7 | 6 | | | | | | 20 | | |
| K₂O | 3 | 3 | | | | | | | | |
| ZrO₂ | 1 | 2 | | | | | | | | |
| P₂O₅ | | | | | | | | | | |
| Ti₂O | 1 | | | | | | | | | |
| Ta₂O₅ | | | | | | | | | | 30 |
| Bi₂O₃ | | | | | | | | | 30 | |
| Ga₂O₃ | | | | | | | | | 20 | |
| PbO | | | | | | | | | 50 | |
| Total | 100 | 100 | 100 | 100 | 100 | 100 | 100 | 100 | 100 | 100 |
| density | 2.47 | 2.47 | 2.51 | 2.61 | 2.69 | 2.20 | 2.14 | 2.19 | 8.27 | 5.19 |
| (×10³ kg/m³) | | | | | | | | | | |
| Young's modulus | 83 | 83 | 76 | 100 | 117 | 73 | 59 | 46 | 51 | 140 |
| (GPa) | | | | | | | | | | |
| compressive | — | — | — | — | — | — | — | — | — | — |
| stress value | | | | | | | | | | |
| (MPa) | | | | | | | | | | |
| depth of | — | — | — | — | — | — | — | — | — | — |
| compressive | | | | | | | | | | |
| stress layer (μm) | | | | | | | | | | |
| acoustic velocity | 5797 | 5797 | 5503 | 6199 | 6584 | 5745 | 5264 | 4588 | 2493 | 5196 |
| (m/s) | | | | | | | | | | |
| acoustic | 14.3 | 14.3 | 13.8 | 16.2 | 17.7 | 12.6 | 11.3 | 10.0 | 20.6 | 27.0 |
| impedance (×10⁶ kg/m²/s) | | | | | | | | | | |

Each of the chemically strengthened glasses according to Examples 1 to 7 and the glasses according to Examples 8 to 19 was used as a cover member, and an ultrasonic fingerprint authentication sensor was disposed as an ultrasonic unit as illustrated in FIG. 1. Thus, an ultrasonic fingerprint authentication sensor device was manufactured as an ultrasonic device. Two kinds of frequencies, that is, 16 MHz and 19 MHz were used as transmission frequencies of the ultrasonic fingerprint authentication sensor. At each frequency, a fingerprint as an object to be detected was detected and imaged (fingerprint imaging test), and it was checked whether clarity with a level high enough to perform authentication could be obtained or not.

In each of the ultrasonic fingerprint authentication sensors manufactured by the chemically strengthened glasses according to Examples 1 to 7 and the glasses according to Examples 8 to 18, the image of the fingerprint obtained finally was clear regardless of the transmission frequency, and sensing sensitivity with a level high enough to perform authentication was obtained. However, in the ultrasonic fingerprint authentication sensor manufactured by Example 19, the fingerprint image obtained particularly at the frequency of 16 MHz was not clear, and sensing sensitivity which cannot be used for authentication was obtained.

In addition, the following test was performed in order to check whether each cover glass could withstand practical use or not.

Sheet paper #30 GBS30 made by TRUSCO NAKAYAMA Corporation was placed on a smooth plate made of SUS so that a use surface of the sheet paper faced up. Each of the chemically strengthened glasses according to Examples 1 to 7 and the glasses according to Examples 8 to 18 was placed on the sheet paper. An iron ball of 65 g was dropped thereon from a height of 150 cm. Thus, each glass to which impact had been applied was obtained. For each glass to which impact had been applied, an ultrasonic fingerprint authentication sensor was disposed as an ultrasonic unit as illustrated in FIG. 1. Thus, an ultrasonic fingerprint authentication sensor device was manufactured as an ultrasonic device. Incidentally, the glasses according to Examples 16 to 18 were entirely crushed when the impact was applied thereto. Therefore, an ultrasonic fingerprint authentication sensor device could not be manufactured for each of the glasses according to Examples 16 to 18. It is considered that this is because the Young's modulus is so low that mechanical strength is low. These glasses can be used in a site where no load is applied.

In each of the ultrasonic fingerprint authentication sensors manufactured by the chemically strengthened glasses according to Examples 1 to 7 and the glasses according to Examples 8 to 15, to which impact had been applied, the image of the fingerprint obtained finally was clear regardless of the transmission frequency, and sensing sensitivity with a level high enough to perform authentication was obtained.

For each of the chemically strengthened glasses according to Examples 1 to 7 and the glasses according to Examples 8 to 15, a reciprocating rubbing test for 100,000 cycles was further performed using calico as a friction material in a state where a load of 1 kg was loaded on the glass. With each of the chemically strengthened glasses according to Examples 1 to 7 and the glasses according to Examples 8 to 15 which were subjected to the reciprocating sliding test, an ultrasonic fingerprint authentication sensor was disposed as an ultrasonic unit as illustrated in FIG. 1. Thus, an ultrasonic fingerprint authentication sensor device was manufactured as an ultrasonic device. As a result, in each of the chemically strengthened glasses according to Examples 1 to 8, the image of the fingerprint obtained finally was clear regardless of the transmission frequency, and sensing sensitivity with a level high enough to perform authentication was obtained. On the other hand, in each of the glasses according to Examples 8 to 15, scratch could be visually recognized in the glass surface. Clear images could be obtained only two or three times out of fingerprint imaging tests performed ten times.

The above shows that the chemically strengthened glass or the glass according to each of the working examples is useful as a cover member for protecting an ultrasonic unit.

The present application is based on Japanese Patent Application No. 2016-176326 filed on Sep. 9, 2016, the contents of which are incorporated herein by reference.

### INDUSTRIAL APPLICABILITY

The cover member according to the present invention can be used as a cover member for an electronic apparatus such as a display device, a mobile display device of a cellular phone, a tablet PC or the like, a clock, a watch, a wearable display, a remote controller, etc. The cover member according to the present invention can be used as a cover member for a fixed biometric authentication device which is not mobile. In addition, the cover member according to the present invention can be used as a cover member for use in a start switch as an on-vehicle device of transportation equipment or the like.

### DESCRIPTION OF REFERENCE NUMERALS AND SIGNS

1 ultrasonic device
3 cover member
31 first main surface
33 second main surface
35 interface
37 interface
39 interface
5 ultrasonic unit
51 transmitter
53 receiver
59 interface
9 printed layer

1. A cover member having:
a first main surface, and
a second main surface which is a side on which an ultrasonic unit is to be disposed,
wherein the cover member comprises a member having an acoustic impedance Z of 3 to 25 (×10⁶ kg/m²/s).

2. The cover member according to claim 1, wherein the member is a glass.

3. The cover member according to claim 2, wherein the glass is an inorganic glass.

4. The cover member according to claim 1, wherein the member has a thickness of 0.1 mm to 1.5 mm.

5. The cover member according to claim 1, wherein the member has a hole or a concave portion.

6. The cover member according to claim 1, which is to protect the ultrasonic unit.

7. The cover member according to claim 6, wherein the ultrasonic unit is an ultrasonic sensor.

8. The cover member according to claim 5, wherein a frequency of ultrasonic waves to be used in the ultrasonic unit is 1 MHz to 30 MHz.

9. The cover member according to claim 1, wherein the member has a Young's modulus of 60 GPa or more.

10. The cover member according to claim 1, wherein the first main surface has an arithmetic average roughness Ra of 5,000 nm or less.

11. The cover member according to claim 1, wherein the member has a compressive stress layer in at least one of the main surfaces.

12. A portable information terminal comprising the cover member according to claim 1.

13. A display device comprising the cover member according to claim 1.

14. An ultrasonic device comprising:
a cover member having a first main surface and a second main surface; and
an ultrasonic unit disposed on a side of the second main surface,
wherein the cover member comprises a member having an acoustic impedance Z of 3 to 25 (×10⁶ kg/m²/s).

15. The ultrasonic device according to claim 14, wherein the ultrasonic unit has a transmitter and a receiver, and a frequency of ultrasonic waves to be transmitted from the transmitter is 1 MHz to 30 MHz.

16. The ultrasonic device according to claim 14, wherein the member is an inorganic glass.

17. The ultrasonic device according to claim 14, wherein the ultrasonic unit is an ultrasonic sensor.

18. The ultrasonic device according to claim 14, wherein the member has a hole or a concave portion.
